(19) United States
(12) Patent Application Publication
(10) Pub. No.: US 2017/0061369 A1
(43) Pub. Date: Mar. 2, 2017

(54) REAL-TIME TRACKING OF STATUS ASSOCIATED WITH SHIPMENT OF A PLURALITY OF CONSIGNMENTS

(71) Applicant: HCL Technologies Limited, Uttar Pradesh (IN)

(72) Inventors: Krishna Kumar RAMAMOORTHY, Chennai (IN); Madhusudhan R. M, Chennai (IN)

(21) Appl. No.: 15/200,953

(22) Filed: Jul. 1, 2016

(30) Foreign Application Priority Data
Jul. 4, 2015 (IN) 2033/DEL/2015

(51) Int. Cl. G06Q 10/08; G06F 17/30

(52) U.S. Cl. CPC G06Q 10/0833; G06F 17/30312

(57) ABSTRACT

Disclosed is a system for real-time tracking of status associated with shipment of a plurality of consignments. An input file upload module uploads an input file comprising details of one or more parameters associated to each of a plurality of consignments. An address determining module determines an address of a carrier website corresponding to each of the plurality of consignments. The address may be determined based on a prefix number concatenated with the unique identification number. A communication module communicates, in real-time with the carrier website via the address in order to extract shipment status of each of the plurality of consignments. A collating module collates the shipment status corresponding to each of the plurality of consignments. A display module displays the shipment status collated in a pre-defined format to a user thereby facilitating the real-time tracking of status associated with shipment of the plurality of consignments.

### PRIORITY INFORMATION

The present application claims benefit from Indian Complete Patent Application No. 2033/DEL/2015, filed on Jul. 04 2015, the entirety of which is hereby incorporated by reference.

### TECHNICAL FIELD

The present subject matter described herein, in general, relates to, information management, and more particularly relates to system and method for real-time tracking of status associated with shipment of a plurality of consignments.

### BACKGROUND

Today, primary objective for development of logistics service providers is to enable their customers involved in freight management to gain visibility of each event across a shipment lifecycle within their multiple systems globally. But due to lack of real-time traceability of each event, the customers may not be provided with updated information by the logistics service providers which hinder the customers for effective decision making resulting in low customer satisfaction levels. Some of the challenges faced by the logistics service providers may include, but not limited to, lack of real-time visibility of shipments across freight management operations, inability to meet customer commitments on time, leading to poor customer satisfaction, lack of process standardization, stations working in silos, high level of manual processes, resulting in time consuming critical customer service activities, and no single source of truth, making it difficult to get the right information at the right time.

One of the reasons for the aforementioned challenges faced by the logistics service providers is the complexity involved in multi-model transportation, which is linked to a single consignment of the shipment lifecycle, making it harder to track and maintain in a single location. In order to facilitate the real-time traceability, a complex network of dynamically connected states may be created which become increasingly hard to track and maintain in a single location. Most of the global logistics organizations have grown out of mass acquisitions of smaller local companies and are dependent on separate systems for their daily activities. When the scale of business increases in a smaller quantum of time, the need to address issues of data integrity, visibility and real-time information gathering become even more critical.

### SUMMARY

Before the present systems and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to systems and methods for real-time tracking of status associated with shipment of a plurality of consignments and the concepts are further described below in the detailed description. This summary is not intended to identify essential features of the claimed subject matter nor is it intended for use in determining or limiting the scope of the claimed subject matter.

In one implementation, a system for real-time tracking of status associated with shipment of a plurality of consignments is disclosed. In one aspect, the system may comprise a processor and a memory coupled to the processor. The processor may execute a plurality of modules stored in the memory. The plurality of modules may comprise an input file upload module, an address determining module, a communication module, a collating module and a display module. The input file upload module may upload an input file comprising details of one or more parameters associated to each of a plurality of consignments. In one aspect, each consignment may have a unique identification number. The address determining module may determine an address of a carrier website corresponding to each of the plurality of consignments. The address may be determined based on a prefix number concatenated with the unique identification number. The communication module may communicate, in real-time with the carrier website via the address in order to extract shipment status of each of the plurality of consignments. The collating module may collate the shipment status corresponding to each of the plurality of consignments. The display module may display the shipment status collated in a pre-defined format to a user thereby facilitating the real-time tracking of status associated with shipment of the plurality of consignments.

In another implementation, a method for real-time tracking of status associated with shipment of a plurality of consignments is disclosed. In one aspect, in order to enable real-time tracking of status, initially, an input file may be uploaded. The input file may comprise details of one or more parameters associated to each of a plurality of consignments. In one aspect, each consignment may have a unique identification number. Upon uploading the input file, an address of a carrier website corresponding to each of the plurality of consignments may be determined. The address may be determined based on a prefix number concatenated with the unique identification number. Subsequent to the determination of the address, the carrier website may be communicated, in real-time, via the address in order to extract shipment status of each consignment. After communicating with the carrier website, the shipment status corresponding to each of the plurality of consignments may be collated. Upon collating, the shipment status collated may be displayed in a pre-defined format to a user thereby facilitating real-time tracking of status associated with shipment of the plurality of consignments. In one aspect, the aforementioned method for real-time tracking of status associated with shipment of a plurality of consignments is performed by a processor using programmed instructions stored in a memory.

In yet another implementation, non-transitory computer readable medium embodying a program executable in a computing device for real-time tracking of status associated with shipment of a plurality of consignments is disclosed. The program may comprise a program code for uploading an input file comprising details of one or more parameters associated to each of a plurality of consignments, wherein each consignment is having a unique identification number. The program may further comprise a program code for determining an address of a carrier website corresponding to each of the plurality of consignments, wherein the address is determined based on a prefix number concatenated with the unique identification number, The program may further comprise a program code for communicating, in real-time with the carrier website via the address in order to extract shipment status of each of the plurality of consignments. The program may further comprise a program code for collating the shipment status corresponding to each of the plurality of consignments. The program may further comprise a program code for displaying the shipment status collated in a pre-defined format to a user thereby facilitating real-time tracking of status associated with shipment of the plurality of consignments.

### BRIEF DESCRIPTION OF THE DRAWINGS

The foregoing detailed description of embodiments is better understood when read in conjunction with the appended drawings. For the purpose of illustrating the disclosure, example constructions of the disclosure is shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for real-time tracking of status associated with shipment of a plurality of consignments, in accordance with an embodiment of the present subject matter.

FIG. 2 illustrates the system, in accordance with an embodiment of the present subject matter.

FIGS. 3A-B, FIGS. 4A-B, and FIGS. 5A-B illustrate examples, in accordance with an embodiment of the present subject matter.

FIG. 6 illustrates a method for real-time tracking of the status associated with shipment of the plurality of consignments, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The primary objective of the system and method of the present disclosure is to facilitate real-time tracking of status associated with shipment of a plurality of consignments. The system and method enables logistics service providers, involved in freight management, and their customers to gain visibility across the shipment lifecycle within multiple systems around the globe. This brings about greater efficiency in routine operations pertaining to the freight management by increased automation of processes, reduction of manual errors, elimination of multiple or redundant runs to gather information, capturing data in a composite repository and act as an integration, point for all sources of information, Efficient workflow management and enhanced reporting capability, and reduced turn-around time coupled with better information quality.

In order to provide the greater efficiency in the routine operations, the system uploads an input file comprising details of one or more parameters associated to each of a plurality of consignments. Examples of the one or more parameters, may include, but not limited to, a unique identification number, a source station, a destination station, a due date, and a carrier website address. Upon uploading the input file, an address of a carrier website corresponding to each of the plurality of consignments may be determined. The system further extracts latest milestone information pertaining to each consignment of the plurality of consignments during its movement and provides on time information of each shipment through the system. The milestone information may include, but not limited to, information pertaining to shipper, consignee, current status, flight number, product description, container, ULD number, current location, freight value, mode, carrier name, status, consol status, and value.

Upon extracting the milestone information pertaining to each consignment, the system collates the milestone information corresponding to each of the plurality of consignments and displays the milestone information in a pre-defined format to a user thereby facilitating real-time tracking of status associated with shipment of the plurality of consignments.

While aspects of described system and method for real-time tracking of status associated with shipment of a plurality of consignments and may be implemented in any number of different computing systems, environments, and/or configurations, the embodiments are described in the context of the following exemplary system.

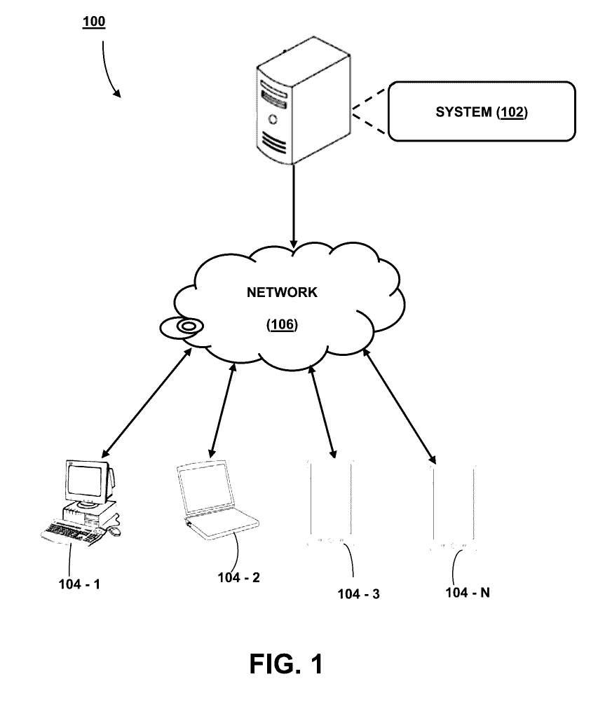

Referring now to FIG. 1, a network implementation 100 of a system 102 for real-time tracking of status associated with shipment of a plurality of consignments is disclosed. In one aspect, in order to real-time tracking of status, initially, the system 102 uploads an input file. The input file may comprise details of one or more parameters associated to each of a plurality of consignments. In one aspect, each consignment may have a unique identification number. Upon uploading the input file, the system 102 determines an address of a carrier website corresponding to each of the plurality of consignments. The address may be determined based on a prefix number concatenated with the unique identification number. Subsequent to the determination of the address, the system 102 communicates the carrier website, in real-time, via the address in order to extract shipment status of each of the plurality of consignments. After communicating with the carrier web site, the system 102 collates the shipment status corresponding to each of the plurality of consignments. Upon collating the shipment status, the system 102 displays the shipment status collated in a pre-defined format to a user thereby facilitating real-time tracking of status associated with shipment of the plurality of consignments.

Although the present disclosure is explained considering that the system 102 is implemented on a server, it may be understood that the system 102 may also be implemented in a variety of computing systems, such as a laptop computer, a desktop computer, a notebook, a workstation, a mainframe computer, a server, a network server, a cloud-based computing environment. It will be understood that the system 102 may be accessed by multiple users through one or more user devices 104-1, 104-2 . . . 104-N, collectively referred to as user 104 or stakeholders, hereinafter, or applications residing on the user devices 104. In one implementation, the system 102 may comprise the cloud-based computing environment in which a user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

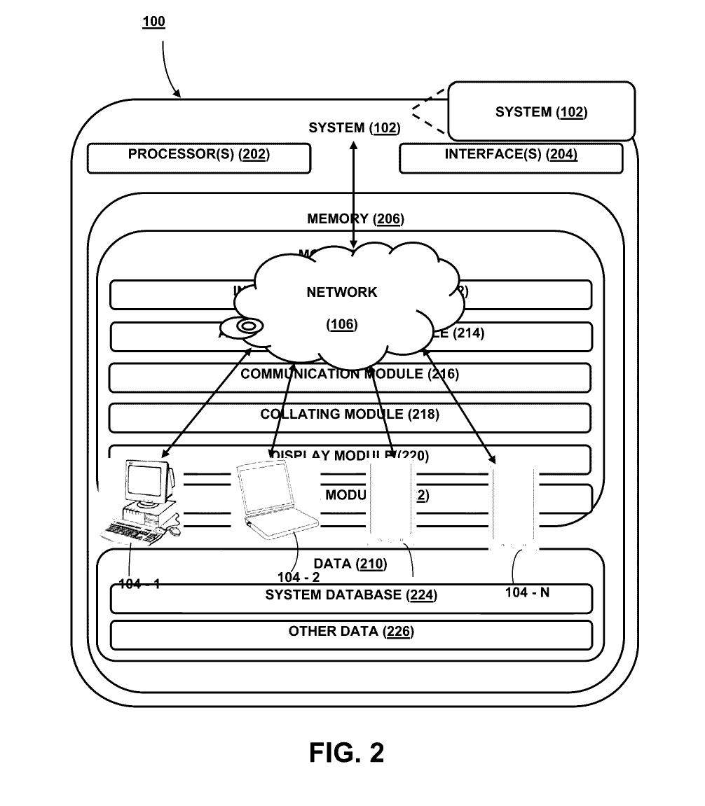

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include an input file upload module 212, an address determining module 214, a communication module 216, a collating module 218, a display module 220 and other modules 222. The other modules 222 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include a system database 224 and other data 226. The other data 226 may include data generated as a result of the execution of one or more modules in the other modules 218.

As there are various challenges observed in the existing art, the challenges necessitate the need for logistics service providers to build the system 102 for real-time tracking of status associated with shipment of a plurality of consignments. The system 102 aims to provide the real-time tracking of the status in order fulfill customer satisfaction levels in accordance with Service Level Agreements (SLAs). A user may use the client device 104 to access the system 102 via the I/O interface 204 in order track the status in real-time. The user may register them using the I/O interface 204 in order to use the system 102. In one aspect, the user may access the I/O interface 204 of the system 102. The system 102 may employ the input file upload module 212, the address determining module 214, the communication module 216, the collating module 218, and the display module 220. The detail functioning of the modules as described below with the help of figures.

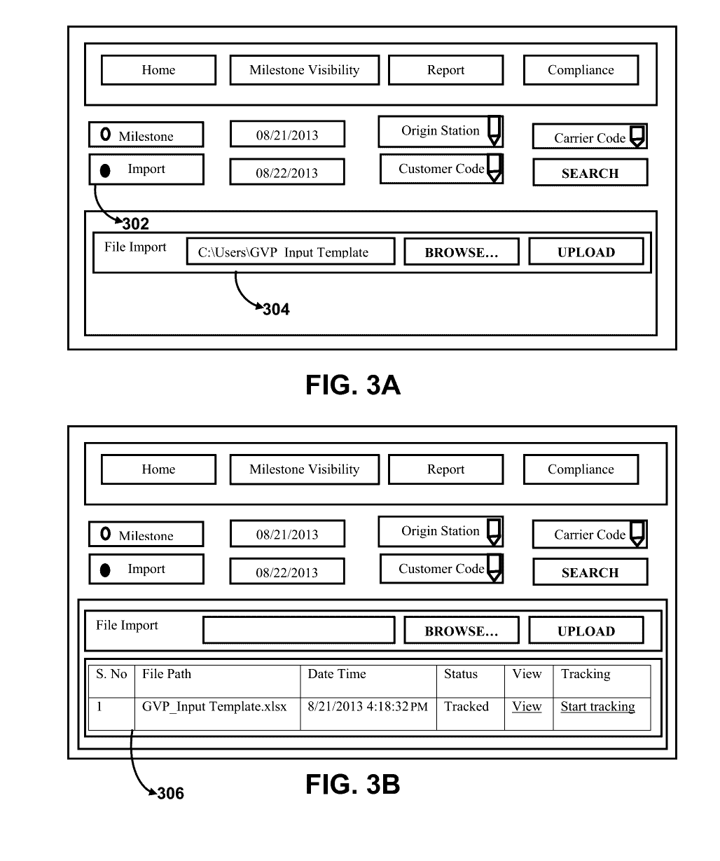

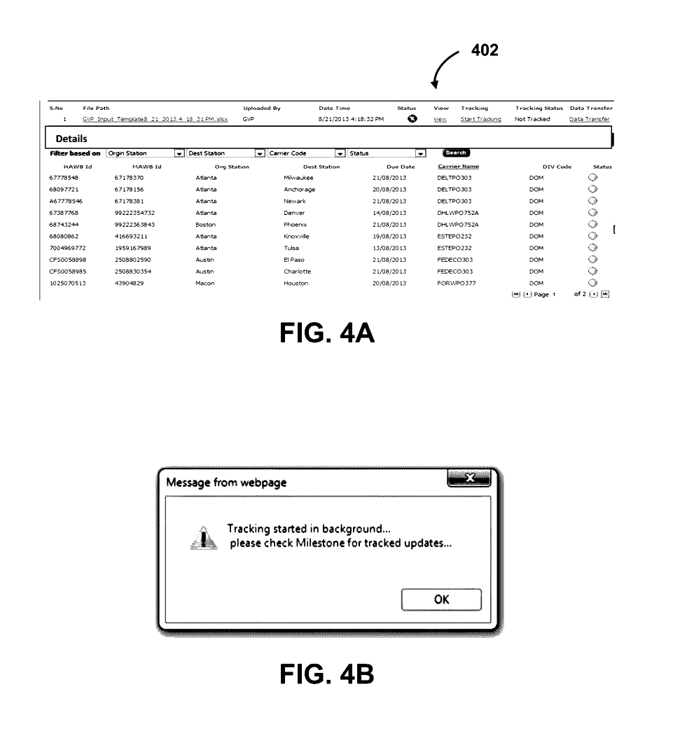

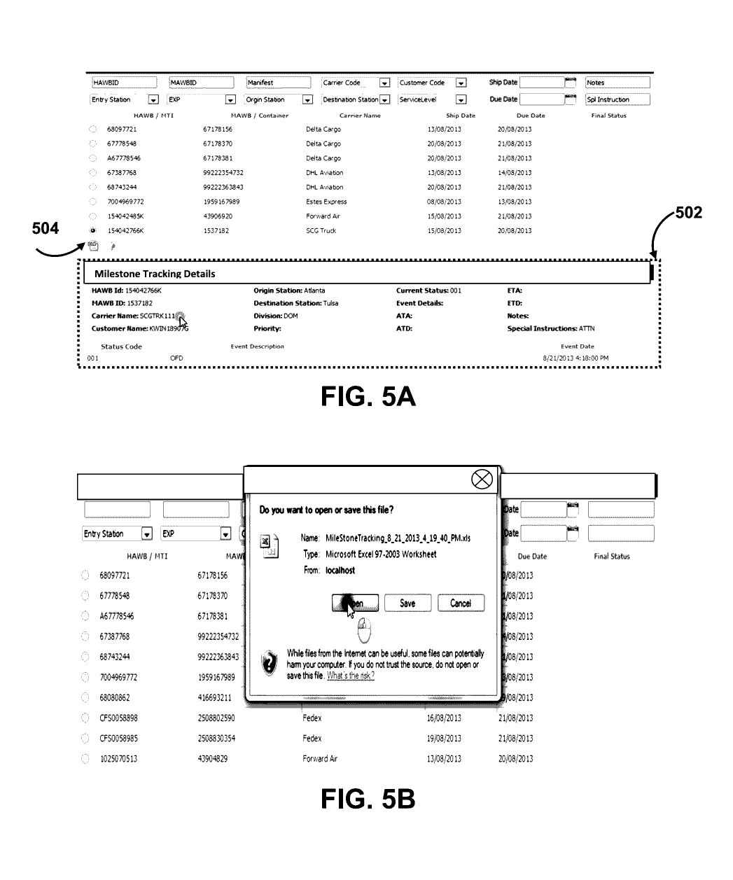

Further referring to FIG. 2, the input file upload module 212 enables the user to upload an input file. In one aspect, the input file may comprise details of one or more parameters associated to each of a plurality of consignments. Examples of the one or more parameters may include, but not limited to, a unique identification number, a source station, a destination station, a due date, and a carrier website address. It may be understood that each consignment may have a unique identification number for identifying each consignment. In one example FIGS. 3(a) and 3(b) illustrates the functioning of the input file upload module 212 where the input file comprising the one or more parameters is being uploaded. As shown in the FIG. 3(a), in order to upload the input file (‘GVP_Input_Template_21_2013_4_18_31PM.xlsx’), an import radio button 302 is displayed to the user. Upon selecting the import radio button 302, the input file upload module 212 enables the user to select the input file stored either on local disk of the system 102 or any other computing system 104(1)-104(4) connected, via the network 106, with the system 102. Once the user the selects the input file, the source path of the input file may be determined and displayed to the user as shown in block 304. Subsequently the input file upload module 212 further enables to upload the input file using an ‘Upload’ button. Upon uploading, the input file upload module 212 further displays metadata corresponding to the input file for the user reference as shown in block 306 of the FIG. 3(b). In one aspect, the metadata may include, but limited to, ‘File name’, ‘name of the user uploaded the input file’, ‘Date and time of uploading the input file’, ‘Status’, and ‘Tracking Status’. Thus, in this manner, the input file upload module 212 facilitates to upload the input file in the system 102.

Subsequent to the uploading the input file, the address determining module 212 determines an address of a carrier website corresponding to each of the plurality of consignments. In one aspect, the address may be determined based on a prefix number concatenated with the unique identification number. In one aspect, the unique identification number may be an Airway Bill (AWB) identification number, a House Airway Bill (HAWB) identification number, or a Master Airway Bill (MAWB) identification number. In one embodiment, the address may be determined based on a pre-defined mapping of each prefix number with the address of a carrier website, and wherein the pre-defined mapping is stored in the system database 224. As shown in FIG. 4(a), the input file (‘GVP_Input_Template_21_2013_4_18_31PM.xlsx’) is being uploaded by the user. It must be further understood from the FIG. 4(a) that the input file comprises a plurality of consignments identified by the unique identification number corresponding to each consignment. Upon referring to the FIG. 4(a), it must be understood that the HAWB number corresponding to first three consignments having the same three digit prefix number i.e. ‘671’ whereas the HAWB number of the first three consignments are different. Thus, based on the prefix number i.e. ‘671’, the address determining module 214 determines carrier name ‘DELTPO303’ in this case and thereby the address of the carrier website based on the pre-defined mapping of each prefix number with the address of a carrier website stored in the system database 224.

After determining the address, the communication module 216 communicates, in real-time with the carrier website via the address in order to extract shipment status of each of the plurality of consignments. As shown in the FIG. 4(a), the user may visit ‘Start Tracking’ 402 hyperlink for extracting the shipment status. Once the ‘Start Tracking’ 402 is clicked, a status message indicating the extraction of the shipment status of the plurality of consignments is displayed to the user as shown in FIG. 4(b).

After extracting the shipment status, the collating module 218 collates the shipment status corresponding to each of the plurality of consignments. As shown in FIG. 5(a), the shipment status corresponding to each of the plurality of consignments, present in the input file, are extracted. In one embodiment, the shipment status may include, but not limited to, ‘HAWB Id number’, ‘MAWB Id number’, ‘Carrier name’, ‘Shipment Date, ‘Due Date’, and ‘Final Status’. In one example, the shipment status pertaining to ‘HAWB Id: 154042766K’ is extracted from the respective carrier website. It may be understood that the latest shipment status for the aforementioned ‘HAWB Id’ is extracted for the event ‘OFD’ at ‘Aug. 21, 2013 at 6.00 PM’ shown in block 502. Similarly the latest shipment status pertaining to each consignment may be extracted from the respective carrier website.

Subsequently, the display module 220 displays the shipment status collated in a pre-defined format to a user thereby facilitating real-time tracking of the status associated with the shipment of the plurality of consignments. As shown in the FIG. 5(a), the display module 220 may further enable the user to select the pre-defined format by using a display button 504. Upon clicking the display button 504, the status associated with the shipment of the plurality of consignments may be displayed in the pre-defined format selected by the user as shown in FIG. 5(b). Thus, in this manner, the status associated with the shipment of the plurality of consignments may be tracked in real-time at a single instance.

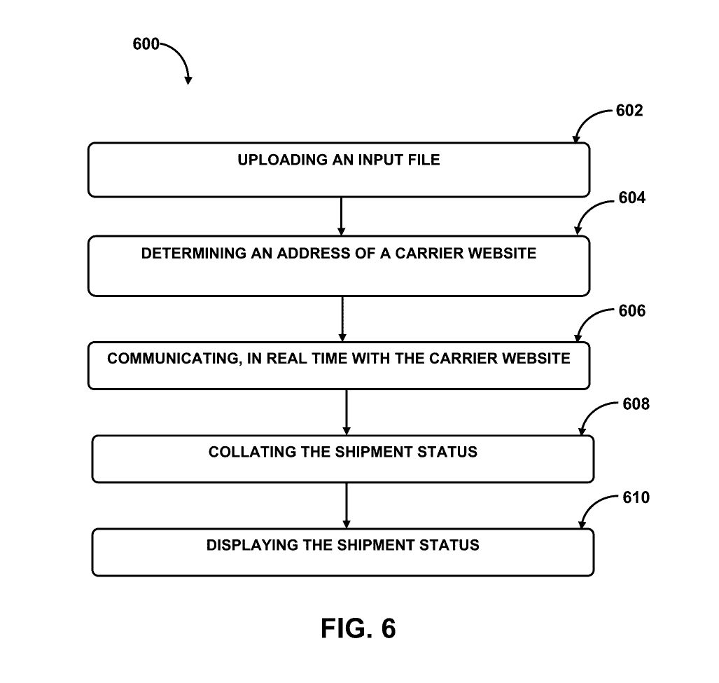

Referring now to FIG. 6, a method 600 for real-time tracking of status associated with shipment of a plurality of consignments is shown, in accordance with an embodiment of the present subject matter. The method 600 may be described in the general context of computer executable instructions. Generally, computer executable instructions can include routines, programs, objects, components, data structures, procedures, modules, functions, etc., that perform particular functions or implement particular abstract data types. The method 600 may also be practiced in a distributed computing environment where functions are performed by remote processing devices that are linked through a communications network. In a distributed computing environment, computer executable instructions may be located in both local and remote computer storage media, including memory storage devices.

The order in which the method 600 is described is not intended to be construed as a limitation, and any number of the described method blocks can be combined in any order to implement the method 600 or alternate methods. Additionally, individual blocks may be deleted from the method 600 without departing from the spirit and scope of the subject matter described herein. Furthermore, the method can be implemented in any suitable hardware, software, firmware, or combination thereof. However, for ease of explanation, in the embodiments described below, the method 600 may be considered to be implemented as described in the system 102.

At block 602, an input file may be uploaded. The input file may comprise details of one or more parameters associated to each of a plurality of consignments. In one aspect, each consignment may have a unique identification number. In one implementation, the input file may be uploaded by the input file upload module 212.

At block 604, an address of a carrier website corresponding to each of the plurality of consignments may be determined. The address may be determined based on a prefix number concatenated with the unique identification number. In one implementation, the address of the carrier website may be determined by the address determining module 214.

At block 606, the carrier website may be communicated, in real-time, via the address in order to extract shipment status of each of the plurality of consignments. In one implementation, the carrier website may be communicated by the communication module 216.

At block 608, the shipment status corresponding to each of the plurality of consignments may be collated. In one implementation, the shipment status corresponding to each of the plurality of consignments may be collated by the collating module 218.

At block 610, the shipment status collated may be displayed in a pre-defined format to a user thereby facilitating real-time tracking of status associated with shipment of the plurality of consignments. In one implementation, the shipment status may be displayed by the display module 220.

Exemplary embodiments discussed above may provide certain advantages. Though not required to practice aspects of the disclosure, these advantages may include those provided by the following features.

Some embodiments enable a system and a method for effective management of Service Level Agreement (SLA) by eliminating manual intervention, through automation, for tracking status associated with each of the plurality of consignments.

Some embodiments enable a system and a method to enhance visibility based on singular on time information about every single shipment.

Some embodiments enable a system and a method to improve customer satisfaction based on high level of data accuracy, integrity and timeliness and enhanced visibility and leveled efficiency.

Although implementations for methods and systems for real-time tracking of status associated with shipment of a plurality of consignments have been described in language specific to structural features and/or methods, it is to be understood that the appended claims are not necessarily limited to the specific features or methods described. Rather, the specific features and methods are disclosed as examples of implementations for the real-time tracking of the status.

We claim:

1. A method for real-time tracking of status associated with shipment of a plurality of consignments, the method comprising:
uploading, by a processor, an input file comprising details of one or more parameters associated to each of a plurality of consignments, wherein each consignment is having a unique identification number;
determining, by the processor, an address of a carrier website corresponding to each of the plurality of consignments, wherein the address is determined based on a prefix number concatenated with the unique identification number;
communicating, in real-time, by the processor, with the carrier website via the address in order to extract shipment status of each of the plurality of consignments;
collating, by the processor, the shipment status corresponding to each of the plurality of consignments; and
displaying, by the processor, the shipment status collated in a pre-defined format to a user thereby facilitating real-time tracking of status associated with shipment of the plurality of consignments.

2. The method of claim 1, wherein the one or more parameters comprises a unique identification number, a source station, a destination station, a due date, and a carrier website address.

3. The method of claim 1, wherein the shipment status comprises information pertaining to shipper, consignee, current status, flight number, product description, container, ULD number, current location, freight value, mode, carrier name, status, consol status, and value,

4. The method of claim 1, wherein the address is further determined based on a pre-defined mapping of each prefix number with an address of a carrier website, and wherein the pre-defined mapping is stored in a database,

5. A method for real-time tracking of status associated with shipment of a plurality of consignments, the method comprising:
a processor; and
a memory coupled to the processor, wherein the processor is capable of executing plurality of modules stored in the memory, and wherein the plurality of modules comprising:
an input file upload module for uploading an input file comprising details of one or more parameters associated to each of a plurality of consignments, wherein each consignment is having a unique identification number;
an address determining module for determining an address of a carrier website corresponding to each of the plurality of consignments, wherein the address is determined based on a prefix number concatenated with the unique identification number;
a communication module for communicating, in real-time with the carrier website via the address in order to extract shipment status of each of the plurality of consignments;
a collating module for collating the shipment status corresponding to each of the plurality of consignments; and
a display module for displaying the shipment status collated in a pre-defined format to a user thereby facilitating real-time tracking of status associated with shipment of the plurality of consignments.

6. The system of claim 5, wherein the one or more parameters comprises a unique identification number, a source station, a destination station, a due date, and a carrier website address.

7. The system of claim 5, wherein the shipment status comprises information pertaining to shipper, consignee, current status, flight number, product description, container, ULD number, current location, freight value, mode, carrier name, status, consol status, and value.

8. The system of claim 5, wherein the address is further determined based on a pre-defined mapping of each prefix number with an address of a carrier website, and wherein the pre-defined mapping is stored in a database,

9. A non-transitory computer readable medium embodying a program executable in a computing device for real-time tracking of status associated with shipment of a plurality of consignments, the program comprising a program code:
a program code for uploading an input file comprising details of one or more parameters associated to each of a plurality of consignments, wherein each consignment is having a unique identification number;
a program code for determining an address of a carrier website corresponding to each of the plurality of consignments, wherein the address is determined based on a prefix number concatenated with the unique identification number;
a program code for communicating, in real-time with the carrier website via the address in order to extract shipment status of each of the plurality of consignments;
a program code for collating the shipment status corresponding to each of the plurality of consignments; and
a program code for displaying the shipment status collated in a pre-defined format to a user thereby facilitating real-time tracking of status associated with shipment of the plurality of consignments.
